(19) United States
(12) Patent Application Publication
(10) Pub. No.: US 2024/0211259 A1
(43) Pub. Date: Jun. 27, 2024

(54) PREFETCHING WITH SATURATION CONTROL

(71) Applicant: Akeana, Inc., San Jose, CA (US)

(72) Inventors: James Youngsae Cho, Los Gatos, CA (US); Rabin Sugumar, Sunnyvale, CA (US)

(73) Assignee: Akeana, Inc., San Jose, CA (US)

(21) Appl. No.: 18/396,792

(22) Filed: Dec. 27, 2023

Related U.S. Application Data
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/463,371, filed on May 2, 2023.
(60) Provisional application No. 63/462,542, filed on Apr. 28, 2023.
(60) Provisional application No. 63/444,619, filed on Feb. 10, 2023.
(60) Provisional application No. 63/439,761, filed on Jan. 18, 2023.
(60) Provisional application No. 63/436,133, filed on Dec. 30, 2022.
(60) Provisional application No. 63/436,144, filed on Dec. 30, 2022.
(60) Provisional application No. 63/435,831, filed on Dec. 29, 2022.
(60) Provisional application No. 63/435,343, filed on Dec. 27, 2022.
(60) Provisional application No. 63/605,620, filed on Dec. 4, 2023.

(51) Int. Cl. G06F 9/30

(52) U.S. Cl. CPC G06F 9/30047

(57) ABSTRACT

Disclosed embodiments provide techniques for data prefetching. A processor core is accessed. The processor core includes prefetch logic and a local cache hierarchy and is coupled to a memory system. A stride of a data stream is detected. The data stream comprises two or more load instructions that cause two or more misses in the local cache hierarchy. Information about the data stream is accumulated. The information includes a stride count. Prefetch operations to the memory system are generated, based on the information. The prefetch operations include prefetch addresses. A rate of the prefetch operations is limited, based on the stride count. Based on the stride count, the prefetcher can enter a saturation state. The saturation state keeps the cache supplied with prefetched data. A number of stride prefetch operations is based on the stride of the data stream. The number is stored in a software-updatable configuration register array.

### RELATED APPLICATIONS

This application claims the benefit of U.S. provisional patent applications “Prefetching With Saturation Control” Ser. No. 63/435,343, filed Dec. 27, 2022, “Prioritized Unified TLB Lookup With Variable Page Sizes” Ser. No. 63/435,831, filed Dec. 29, 2022, “Return Address Stack With Branch Mispredict Recovery” Ser. No. 63/436,133, filed Dec. 30, 2022, “Coherency Management Using Distributed Snoop” Ser. No. 63/436,144, filed Dec. 30, 2022, “Cache Management Using Shared Cache Line Storage” Ser. No. 63/439,761, filed Jan. 18, 2023, “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, and “Cache Snoop Replay Management” Ser. No. 63/605,620, filed Dec. 4, 2023.

Each of the foregoing applications is hereby incorporated by reference in its entirety.

### FIELD OF ART

This application relates generally to computer processors and more particularly to prefetching with saturation control.

### BACKGROUND

Integrated circuits (ICs) can be found in a wide variety of electronic devices such as smartphones, tablets, televisions, laptop computers, desktop computers, gaming consoles, and more. The integrated circuits (chips) enable and greatly enhance device features and utility. These device features render the devices more useful and more central to the users' lives than were even recent, earlier generations of the devices. Many toys and games have benefited from the incorporation of integrated circuits. The chips can include processors and other chips that enhance the games by producing remarkably realistic audio and graphics, enabling players to engage mysterious and exotic digital worlds and situations. Additionally, there are a growing number of low-cost, low-power applications arising in technology areas such as the Internet-of-Things (IOT), instrumentation, remote monitoring, and so on. Processors can vary widely in terms of architecture and features. However, common to most processors is a central processing unit (CPU), one or more registers, and one or more levels of cache memory. Processors utilize registers in order to execute instructions, manipulate data, and execute other features.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define different levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program, to test the logic design. Part of the process may include Register Level Transfer (RTL) abstractions that define the synthesizable data that is fed into a logic synthesis tool, which in turn creates the gate-level abstraction of the design that is used for downstream implementation operations.

The number of logic gates able to be formed in an integrated circuit continues to increase through improvements in lithography, through-silicon vias (TSVs) that enable 3D “stacked” chips, and other manufacturing improvements. Processors with multiple billions of transistors are now in use. The smaller scale of the new transistors enables more power efficiency while also achieving increased density, paving the way for new applications for processor-enabled devices.

### SUMMARY

A cache miss results in an adverse performance impact, since the processors must reach out to the slower, shared, common memory for the requested data. One way to reduce cache misses is with prefetching. Prefetching is a technique that reduces the cache miss rate by fetching data from memory to a cache, ideally before the data has been demanded from the processor. The simplest hardware prefetcher is a Next-N-Line Prefetcher, which fetches one or more cache blocks adjacent to the one that was not found in a cache. If the next block(s) are already in a cache, they are not prefetched. The number of next blocks to prefetch (N) is referred to as “aggressiveness”.

Disclosed embodiments provide techniques for data prefetching. A processor core is accessed. The processor core includes prefetch logic and a local cache hierarchy and is coupled to a memory system. A stride of a data stream is detected. The data stream comprises two or more load instructions that cause two or more misses in the local cache hierarchy. Information about the data stream is accumulated. The information includes a stride count. Prefetch operations to the memory system are generated, based on the information. The prefetch operations include prefetch addresses. A rate of the prefetch operations is limited, based on the stride count. Based on the stride count, the prefetcher can enter a saturation state. The saturation state keeps the cache supplied with prefetched data. A number of stride prefetch operations is based on the stride of the data stream. The number is stored in a software-updatable configuration register array.

A processor-implemented method for prefetching is disclosed comprising: accessing a processor core, wherein the processor core includes prefetch logic and a local cache hierarchy, and wherein the processor core is coupled to a memory system; detecting a stride of a data stream, wherein the data stream comprises two or more load instructions, wherein the two or more load instructions cause two or more misses in the local cache hierarchy; accumulating information about the data stream, wherein the information includes a stride count; generating, based on the information, one or more prefetch operations, to the memory system, wherein the one or more prefetch operations each includes a prefetch address; and limiting a rate of the one or more prefetch operations based on the stride count. Some embodiments comprise performing a first number of stride prefetch operations which is based on the stride of the data stream, wherein the first number is stored in a software-updatable configuration register array. Some embodiments comprise identifying a continuation of the stride of the data stream, wherein the continuation of the data stream comprises two or more additional load instructions, wherein the two or more additional load instructions cause two or more second misses in the local cache hierarchy.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for prefetching with saturation control.

FIG. 2 is a flow diagram for controlling prefetch operations.

FIG. 3 is a multicore processor with prefetch logic.

FIG. 4 is an example pipeline structure including configurable prefetching with throttle control.

FIG. 5 is a block diagram for prefetching with saturation control.

FIG. 6 is a detailed diagram for prefetching with saturation control.

FIG. 7 is a state machine for prefetching with saturation control.

FIG. 8 is a system diagram for configurable prefetching with throttle control.

### DETAILED DESCRIPTION

Processors of various types are found in devices such as personal electronic devices, computers, specialty devices such as medical equipment, household appliances, and vehicles, to name only a few examples. The processors enable the devices within which the processors are located to execute a wide variety of applications. The applications include telephony, messaging, data processing, patient monitoring, vehicle access and operation control, etc. The processors are coupled to additional elements that enable the processors to execute their assigned applications. The additional elements typically include one or more of shared, common memories, communication channels, peripherals, and so on. In order to boost processor performance, and to take advantage of “locality” often found in application code that is executed by the processors, portions of the contents of the common memories can be moved to cache memory. The cache memory, which can be colocated with or closely adjacent to the processors, is often smaller and faster than the common (main) memory. The cache memory can be accessed by some or all of the processors without having to access the slower common memory, thereby reducing access time and increasing processing speed. Access by the processors to the cache memory can continue while data, instructions, etc. are available within the cache. If the requested data is not located within the cache, then a cache miss occurs.

Processors may utilize a memory architecture that includes a hierarchy of memory stores of varying speeds and sizes. Highly requested data may be stored in an on-chip cache. There can be multiple levels of cache. As an example, there can be a level 1 (L1) cache or local cache that is located very close to a processing unit. For each core in a multicore processor, there may be a level 2 (L2) cache dedicated to a given core. There can also be a global level 3 (L3) cache serving the global needs of all the cores. Fetching data from main memory can be considerably slower than fetching it from cache memory. Accessing data that is already in cache can greatly improve processor performance. When a processor accesses data, the cache is checked first. If the data is found in the cache, it is referred to as a cache hit. If the data is not found in the cache, then it is referred to as a cache miss, and the data must be retrieved from a different memory source since it was not found in the cache. It is desirable to maximize the number of cache hits during execution of computer programs and applications, in order to minimize the effects of accessing main memory, which is typically slower than cache memory.

Data prefetching is a technique that can be employed to reduce latency of slow memories. When a processor executes a load or store instruction, it is said to “demand” access to the data. With data prefetching, data is fetched before it is demanded. This can be accomplished by making assumptions about what data the processor will demand in the future, based on what it has demanded in the past. As an example, if a processor demands data at an address X, and again demands data at an address X+64, the processor may also prefetch data at address X+128, since it detected a pattern of fetching data 64 bytes apart in memory. If on a subsequent load/store instruction, the data at X+128 is demanded, it is already in the cache from the prefetch and a cache hit results, increasing processor performance.

Efficient data prefetching can be more complex than the aforementioned example. If data is prefetched too early, there is an increased chance that the prefetched data may not be used. This can be due to instruction branching that causes the execution of the program to change, such that the prefetched data is not needed. Additionally, prefetching too aggressively can cause cache pollution. Cache pollution is a condition in which prefetched data replaces more useful (e.g., demanded) data in the cache. Similarly, prefetching too conservatively can result in limited or no benefits being realized in terms of improved cache hits. If data is prefetched too late, it may not be in the cache by the time it is needed and a processor stall can result. Disclosed embodiments reduce the risk of cache pollution while prefetching data at an initial rate for improved performance due to an increase in cache hits. Thus, with disclosed embodiments, the negative effects of prefetching can be mitigated, resulting in improved processor performance.

Disclosed embodiments provide a processor-implemented method for stride prefetching. Stride prefetching is a hardware prefetching technique that is particularly well suited for matrix operations. For example, in a matrix multiplication of M (n, n) x M (n, n) with matrix M having n row elements and n column elements, it is necessary to fetch each column element to multiply with the row element. In the memory layout, the values within a given column are typically placed at a fixed distance of n elements (based on the data size). This fixed distance can be exploited by a stride pattern access. A prefetcher access with stride M denotes that every M^{th} cache block is accessed. Once a stride access pattern is detected, upon a load miss, the prefetcher fetches one or more blocks according to the stride pattern.

Stride prefetching can be further enhanced using saturation control. By prefetching with saturation control, the aggressiveness of the prefetcher can change during processing of a data stream. The processor can accumulate information about the data stream, including a stride count. Based on the accumulated information, one or more prefetch operations are generated. The rate of the prefetch operations can be limited based on the stride count. This enables the prefetch buffers and/or cache to be prefetched with data as quickly as possible, and then continue at a reduced rate to avoid performance penalties due to overaggressive prefetching.

Techniques for data prefetching are disclosed. The techniques include accessing a processor core, wherein the processor core includes prefetch logic and a local cache hierarchy, and wherein the processor core is coupled to a memory system; detecting a stride of a data stream, wherein the data stream comprises two or more load instructions, wherein the two or more load instructions cause two or more misses in the local cache hierarchy; accumulating information about the data stream, wherein the information includes a stride count; generating, based on the information, one or more prefetch operations, to the memory system, wherein the one or more prefetch operations each includes a prefetch address; and limiting a rate of the one or more prefetch operations based on the stride count. The state of the prefetcher in which the rate is limited is referred to as saturation. The saturation state serves to keep the cache supplied with prefetched data, while throttling the prefetches as compared with the initial prefetch rate, to reduce the risk of cache pollution and other adverse effects.

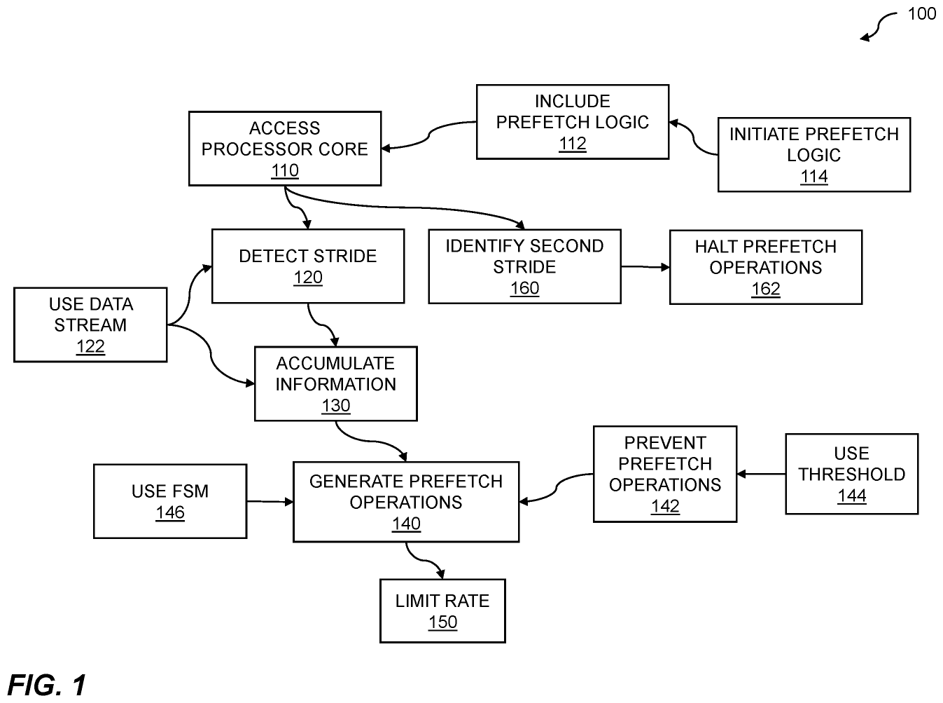

FIG. 1 is a flow diagram 100 for prefetching with saturation control. The flow includes accessing a processor core 110. The processor core can be a Reduced Instruction Set Computer (RISC) core. The processor core may support instructions that can be executed in a pipelined manner, having pipeline stages that may include fetch, decode, and execute. Each of these pipeline stages may take one clock cycle, and thus, the pipelined operation can allow RISC processors to operate on more than one instruction per clock cycle. In embodiments, the processor core can include a RISC-V processor, ARM processor, MIPS processor, or other suitable RISC processor type. The flow includes prefetch logic 112. The prefetch logic can perform prefetching data from one or more memory locations. The data that is prefetched can be stored in a cache, prefetch buffer, or other suitable storage structure. The flow can include initiating prefetch logic 114. The initiating can be based on one or more cache misses by access instructions. Embodiments can include initiating the prefetch logic, wherein the initiating is based on one or more misses by the two or more load instructions. The flow includes detecting a stride 120. In embodiments, the detecting is accomplished using a prefetch cache. The detecting of a stride can include predicting an access pattern in a data stream 122. The access pattern can be based on addresses used by load instructions. The load instructions may be referred to by a program counter (PC) at the time of execution. Access patterns can follow a stride. Examples of stride-based access can include accessing a column of elements within a matrix stored in memory, and/or accessing specific elements in an array of data structures. A regular pattern can be detected, such as X, X+8, X+16, etc. In general, for a stride S, with a prefetch depth of N, the stride prefetching can prefetch data from a base address X, as follows: X+S, X+2S, . . . X+NS. The stride prefetching can have a directionality. For example, in certain computational tasks, a process may start at the end of an array, and iterate towards the beginning of an array. In this case, the stride can have a negative direction, resulting in a stride pattern as follows: X−S, X−2S, . . . X−NS.

The detecting of a stride can be based on the difference in address locations corresponding to two or more consecutive load instructions. The detecting of a stride can include detecting a directionality. The number of consecutive load instructions can be two or more. The number of consecutive load instructions is referred to as a stride count. The flow includes accumulating information 130 on the data stream. The accumulated information can include a stride count. The stride count can be used as a criterion to generate prefetch operations 140. In some embodiments, prefetching occurs when the stride count equals two. In some embodiments, prefetching occurs when the stride count exceeds a predetermined threshold 144. The flow can include preventing prefetch operations 142 until the predetermined threshold is met or exceeded. In embodiments, the predetermined threshold can be two or higher. As an example, in some embodiments, prefetching occurs when the stride count exceeds five. Embodiments can include preventing the generating of one or more prefetch operations until the stride count is above a threshold, wherein the threshold is stored in a software-updatable configuration register array. The software-updatable configuration register array can be programmed by machine instructions. The machine instructions may populate the software-updatable configuration register array based on a detected stride, and/or an inferred stride based on static data structures. Thus, in some embodiments, a compiler may generate instructions for configuration of the prefetcher based on operations on data structures of a known size. In other cases, the stride may be inferred during dynamic execution of processor instructions, and the software-updatable configuration register array can be programmed “on the fly” based on a detected stride.

The stride count can be used as a criterion to limit the amount of prefetching performed by the processor core. In embodiments, when the stride count reaches a predetermined value, the prefetcher enters a saturate mode, which is a limiting mode that reduces the amount of data the prefetcher will prefetch. The flow can include limiting the rate 150 of prefetching. The limiting of the rate can be based on the stride count. Embodiments can include identifying a second stride in the data stream 160. The second stride can be different from the first stride. Programmatically, this can occur when a new data structure is accessed, such as performing operations on an N×N matrix, followed by performing operations on an M×M matrix, where N is unequal to M. When the stride is determined to have changed, the prefetch operations can be halted 162. Thus, embodiments can include halting the one or more prefetch operations, wherein the second stride is different than the stride.

The prefetcher can be implemented using a finite state machine (FSM) 146. A finite state machine is a model of computation based on a hypothetical machine made of one or more states. Only one state of this machine can be active at any given time. The FSM transitions from one state to another in order to perform different actions. Input signals can also cause a transition from one state to another. The FSM can return to a given state periodically. In embodiments, the FSM comprises at least three states. The FSM can be used to manage and control the operations of the prefetcher. Various steps in the flow 100 may be changed in order, repeated, omitted, or the like without departing from the disclosed concepts.

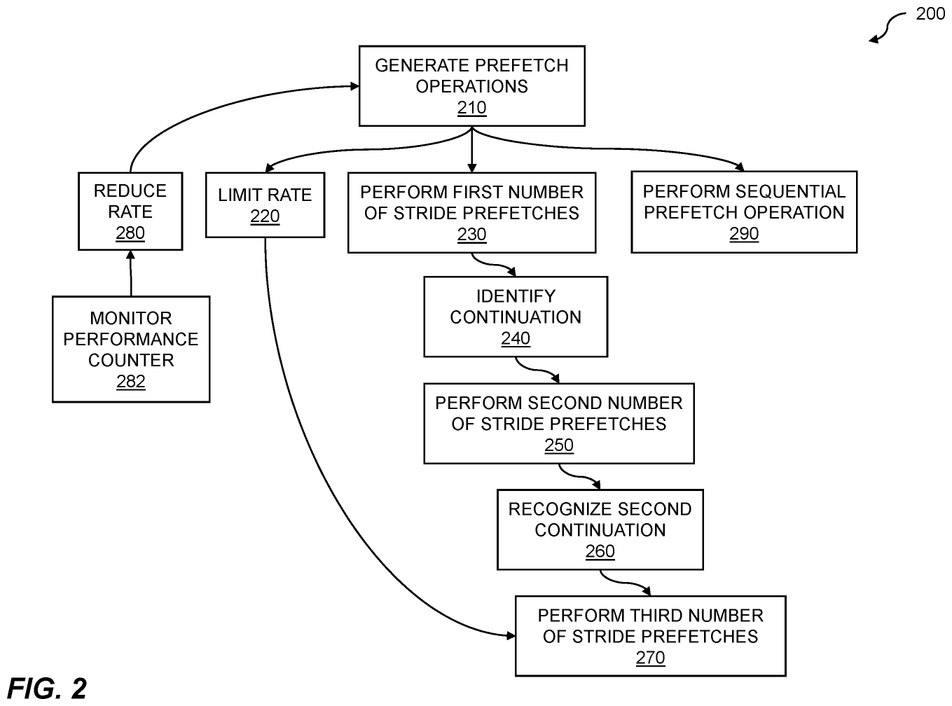

FIG. 2 is a flow diagram 200 for controlling prefetch operations. The flow includes generating prefetch operations 210. The prefetch operations can include prefetching data from main memory and loading it into a buffer memory. The buffer memory can be a cache. The cache can be a dedicated prefetch cache, local cache, L2 cache, L3 cache, or other suitable cache. The flow can include performing a first number of stride prefetches 230. Embodiments can include performing a first number of stride prefetch operations which is based on the stride of the data stream, wherein the first number is stored in a software-updatable configuration register array. In some embodiments, the first number of stride prefetches 230 is four prefetches. The flow can include identifying a continuation 240 of the stride of the data stream. Embodiments can include identifying a continuation of the stride of the data stream, wherein the continuation of the data stream comprises two or more additional load instructions, wherein the two or more additional load instructions cause two or more second misses in the local cache hierarchy. The flow can include performing a second number of stride prefetches 250. Embodiments can include performing a second number of stride prefetch operations which is based on the stride of the data stream, wherein the second number is stored in the software-updatable configuration register array. The flow can include recognizing a second continuation 260 of the stride of the data stream, wherein the second continuation of the data stream comprises two or more further load instructions, wherein the two or more further load instructions cause two or more third misses in the local cache hierarchy. In some embodiments, the second number of stride prefetches can be equal to the first number of stride prefetches performed at 230. In some embodiments, the second number of stride prefetches is four. The flow can include limiting a rate 220 of the one or more prefetch operations based on the stride count. This can include performing a third number of stride prefetches 270. The third number of stride prefetches can be less than the first number and/or second number of stride prefetches. In some embodiments, the third number of stride prefetches is one. Embodiments can include performing a third number of stride prefetch operations, wherein the third number is stored in the software-updatable configuration register array.

The flow can include monitoring a performance counter 282. The performance counter can include recording one or more pieces of information in a register. The one or more pieces of information can include a number of cache access attempts during a given time period, and/or a number of cache misses over that same time period. The number of cache misses can be indicative of performance. If the performance counter is above a predetermined threshold, the flow can include reducing the rate 280 of generated prefetch operations. This can help improve overall processor performance since prefetching instructions that are not significantly helping the cache hit rate are wasting resources such as clock cycles, memory bandwidth, and cache storage. Thus, disclosed embodiments mitigate this situation with improvements in prefetch operations. Embodiments can include monitoring a performance counter in the local cache hierarchy. In embodiments, the generating one or more prefetch operations is reduced based on the performance counter recording a count above a threshold value. The threshold value can be stored in a software-updatable configuration register array. In embodiments, the at least one sequential prefetch operation is based on a next sequential memory location. Under certain conditions, the prefetcher can exit stride mode and return to performing a sequential prefetch operation 290. The conditions can include, but are not limited to, detecting a new stride count, detecting a loss of stride, and/or other conditions. Thus, in embodiments, the generating further comprises performing at least one sequential prefetch operation. Various steps in the flow 200 may be changed in order, repeated, omitted, or the like without departing from the disclosed concepts.

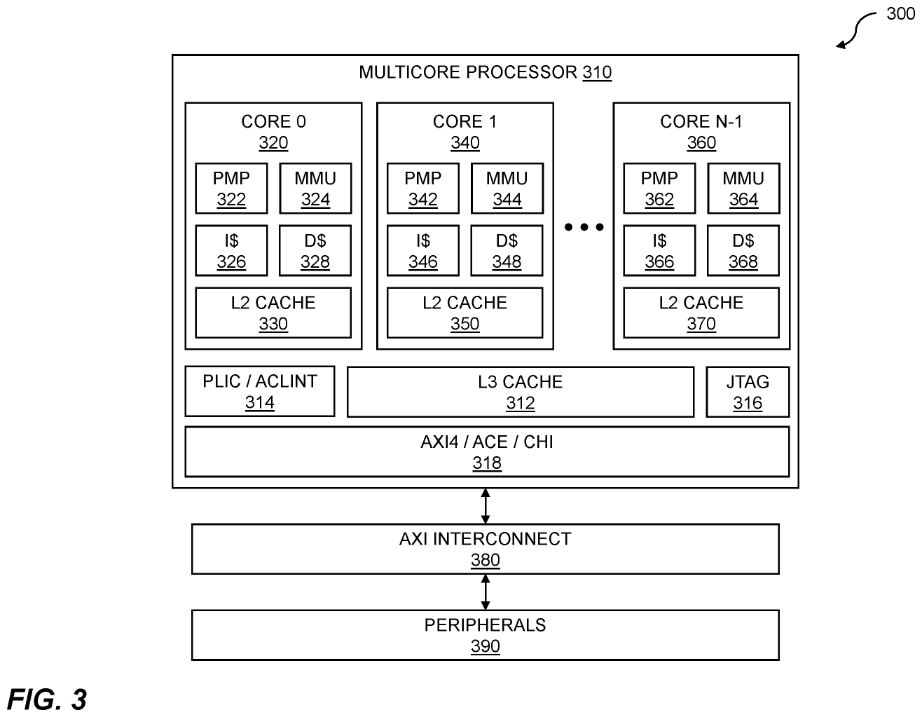

FIG. 3 is a block diagram illustrating a multicore processor with prefetch logic. In embodiments, the multicore processor can be a RISC-V™ processor, ARM™ processor, MIPS™ processor, or some other suitable processor type. The processor can include a multicore processor, where two or more processor cores can be included. The processor, such as a RISC-V™ processor, can include a variety of elements. The elements can include processor cores, one or more caches, memory protection and management units (MMUs), local storage, and so on. The elements of the multicore processor can further include one or more of a private cache; a test interface such as a joint test action group (JTAG) test interface; one or more interfaces to a network such as a network-on-chip, shared memory, or peripherals; and the like. The multicore processor is enabled by processor and network-on-ship coherency management. A plurality of processor cores is accessed. Each processor of the plurality of processor cores accesses a common memory through a coherent network-on-chip, and the coherent network-on-chip comprises a global coherency. A local cache is coupled to a grouping of two or more processor cores of the plurality of processor cores. Prefetcher logic can prefetch sequential data and/or stride-based data to increase the ratio of cache hits to cache access attempts, thereby improving processor performance.

The block diagram 300 can include a multicore processor 310. The multicore processor can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1 can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses with caches, the share memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$326 and a data cache D$328 associated with core 0; an instruction cache I$346 and a data cache D$348 associated with core 1; and an instruction cache I$366 and a data cache D$368 associated with core N-1. In addition to the level 1 instruction and data caches, each core can include a level 2 (L2) cache. The level 2 caches can include an L2 cache 330 associated with core 0; an L2 cache 350 associated with core 1; and an L2 cache 370 associated with core N-1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 314. The platform level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

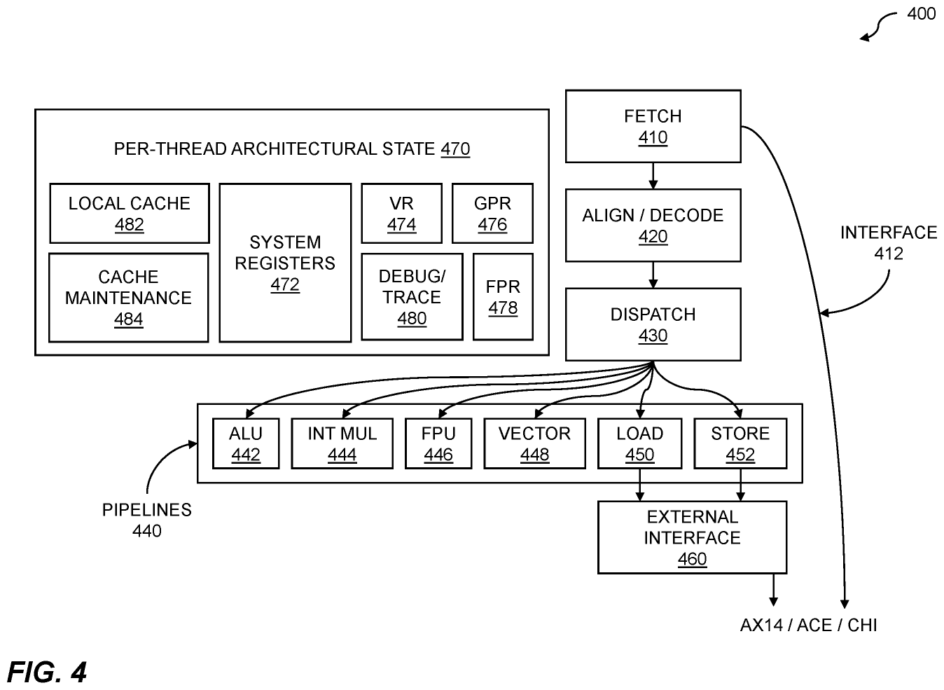

FIG. 4 is an example pipeline structure including configurable prefetching with throttle control. The use of one or more pipelines associated with a processor architecture can greatly enhance processing throughput. The processing throughput can be increased because multiple operations can be executed in parallel. Configurable prefetching with throttle control supports improved processor performance by increasing the probability of cache hits. Prefetching data that is ultimately not used is a waste of processor resources. Furthermore, prefetching data too early increases the likelihood that the data is not used, due to instruction branching, data eviction from the cache, and so on. Similarly, prefetching data too late does not provide the desired performance benefit, as the processor may still stall while the data is being retrieved. Disclosed embodiments that provide a prefetcher that includes configurable prefetching with throttle control can mitigate the aforementioned problems by strategically throttling the prefetching once the cache buffer is sufficiently populated with prefetched data.

FIG. 4 shows a block diagram 400 of a pipeline such as a core pipeline. The blocks within the block diagram can be configurable in order to provide varying processing levels. The varying processing levels can be based on processing speed, bit lengths, and so on. The block diagram 400 can include a fetch block 410. The prefetching logic of disclosed embodiments may be performed by the fetch block 410. The prefetching can include stride data access and can support a saturation mode in which the number of prefetches is reduced. The saturation mode can serve to reduce wasted processor resources such as clock cycles, memory bandwidth, and the like by reducing the prefetched data once the prefetching has acquired a sufficient amount of prefetch data. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The system block diagram 400 can include a dispatch block 430. The dispatch block can receive decoded instruction packets from the align and decode block. The decode instruction packets can be used to control a pipeline 440, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450 and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474, general purpose registers (GPR) 476, and floating-point registers 478. These registers can be used for vector operations, general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

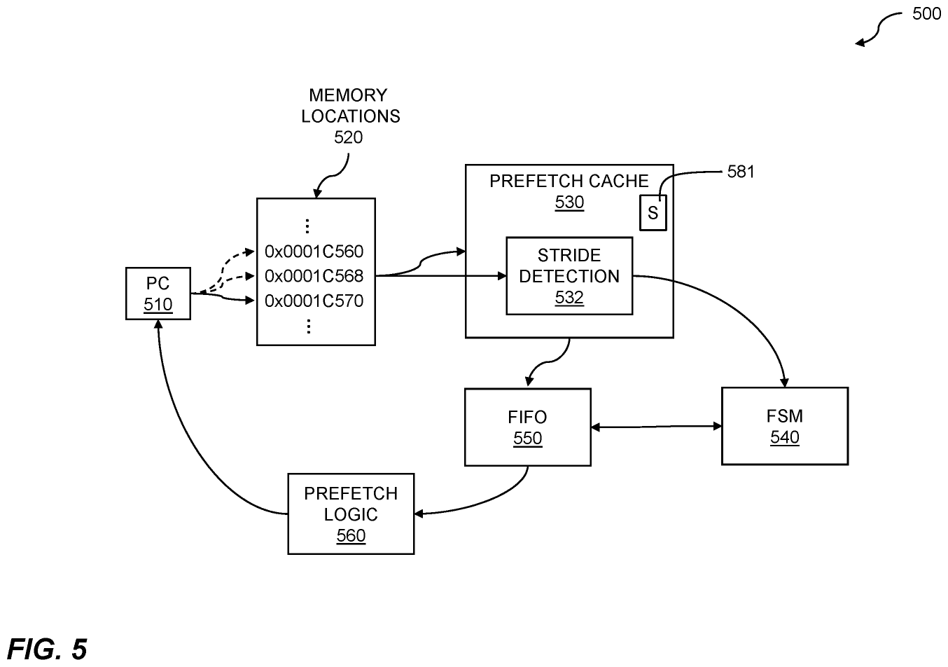

FIG. 5 is a block diagram 500 for prefetching with saturation control. A program counter 510 refers to instructions that include load instructions for multiple memory locations 520. The data referred to by memory locations 520 can be transferred to a prefetch cache 530. The prefetch cache 530 can be a portion of the processor core's prefetching that helps to calculate the address to prefetch. In embodiments, the prefetch cache comprises a tag cache and a data cache. In embodiments, an entry in the tag cache can correspond to an entry in the data cache which contains a load address incremented by a stride amount, stride count, saturation count, and other information. A stride detection block 532 can detect a periodic pattern that can occur with computational tasks such as matrix multiplication, iterating through arrays of structures, and the like. The stride detection block 532 can accumulate various information about a data stream. The accumulated information can be stored in first-in first-out (FIFO) buffer 550. The information in the FIFO buffer 550 can include a stride count, the number of cache misses, and/or other information. The information in the FIFO buffer 550 can be used as input to the prefetch logic 560, which then configures the program counter 510 for the next location for prefetch operations. In embodiments, a saturate bit 581 in a prefetch cache is set. The setting of the saturate bit 581 can indicate that the prefetcher is in saturate mode. In saturate mode, the rate of prefetching can be limited, thereby reducing the adverse effects of prefetching too much data and/or prefetching data too early. Information from stride detection block 532 can be input to the finite state machine 540. The input information can cause a transition from one state to another within FSM 540. The FSM 540 can return to a given state periodically. In embodiments, the FSM comprises at least three states. The FSM can be used to manage and control the operations of the prefetcher.

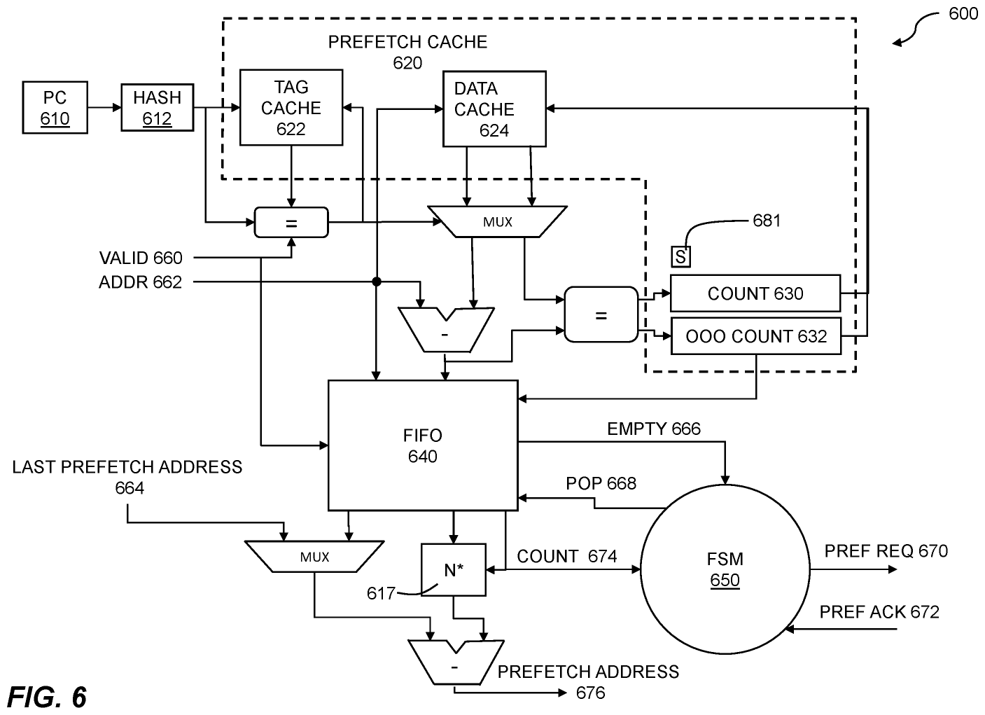

FIG. 6 is a detailed diagram 600 for prefetching with saturation control. A program counter 610 contains a value that is hashed by hash block 612 and input to a tag cache 622 within prefetch cache 620. The prefetch cache 620 also includes a data cache 624. In embodiments, the prefetch cache comprises a tag cache and a data cache. In embodiments, the data cache includes the stride of the data stream. The hash value can be used as an input to the prefetch cache 620 in order to access a value stored in the data cache 624. A last prefetch address 664 is used as an input, along with a valid signal 660 and an address 662, and a current prefetch address 676 can be computed, based on the last prefetch address 664, address 662, and valid signal 660. In embodiments, the prefetch address is based on a load address that missed in the local cache hierarchy, information from the tag cache, information from the data cache, and the stride of the data stream. The current prefetch address 676 may be computed by applying a stride factor to the address 662 via stride block 617. The stride factor can be based on a difference between the address 662 and the address associated with a previous load instruction. Stride block 617 multiplies a stride by a count value 674 to derive the new address. As an example, with an address of 0x1000A800, and a stride factor of 64 bytes, then a new prefetch address of 0x1000A840 can be generated. In cases where more than one prefetch address is generated, the stride factor is applied again, such that the next prefetch address in this example is computed as 0x1000A880, and so on.

Various information can be accumulated within the prefetcher. This can include stride count 630. In embodiments, the stride count refers to the number of consecutive load instructions that refer to memory locations spaced at equal distances from each other, forming a stride pattern. This type of pattern occurs frequently in programming, such as when performing matrix operations. Thus, the prefetchers of disclosed embodiments can serve to improve processor performance, especially with matrix operations. The information can include a saturate bit 681. The saturate bit can be set when the prefetcher is in saturation mode. In embodiments, the saturate bit can be in the data cache 624. In embodiments, the data cache includes a saturate bit. When the prefetcher is in saturation mode, the number of prefetches per cycle can be reduced. By implementing a saturation mode within the prefetcher, disclosed embodiments reduce wasted processor resources, such as clock cycles, memory bandwidth, and the like, by limiting the rate of incoming prefetched data, avoiding issues that are encountered when data is prefetched too early, or too much data is prefetched. In embodiments, an out-of-order (OoO) stride count bit 632 in a prefetch cache is set. Out-of-order execution (OoO) is a technique in computer processors that enables instructions to begin execution as soon as their operands are ready, even if executed out of order. The OoO processing allows the processor to execute a set of instructions more quickly. Depending on the type of instructions and the operands, multiple instructions may be executed out of order. This can include load instructions. When load instructions are executed out of order, it could create an appearance that the stride pattern is broken, causing the prefetcher to exit stride mode prematurely, which could adversely affect prefetcher performance. Disclosed embodiments provide a feature in which when OoO access instructions are occurring, the prefetcher stays in saturation mode. In this way, disclosed embodiments support stride-based prefetcher operations with out-of-order execution of load instructions. In embodiments, the OoO stride count bit 632 can be in the data cache 624. In embodiments, the data cache includes an out-of-order stride count of the data stream.

A finite state machine (FSM) 650 may be used to implement the logic and operations of the prefetcher. The FSM 650 may be coupled to FIFO 640, which contains accumulated information. Thus, in embodiments, the accumulating the information is accomplished by a first-in first-out (FIFO) buffer. The information in the FIFO buffer 640 can include a stride count, a saturation mode status, an out-of-order execution status, a number of cache misses, a valid signal 660, an address 662, and/or other performance information. The FSM 650 may consume information from the FIFO 640. If the FIFO 640 becomes empty, an empty signal 666 is provided to the FSM 650, which can cause the FSM to return to an idle state. When the FIFO 640 is not empty, the FSM 650 can issue a POP 668 for the FIFO 640 to retrieve the next record of accumulated information. Based on the information, a prefetch request 670 can be issued from the FSM 650, causing the prefetching to occur. In embodiments, once the prefetched data is successfully loaded into the cache, a prefetch acknowledge 672 is received by the FSM 650, which can cause the FSM 650 to retrieve the next record from the FIFO 640, if available. Thus, in embodiments, the generating one or more prefetch operations is accomplished by a finite state machine (FSM).

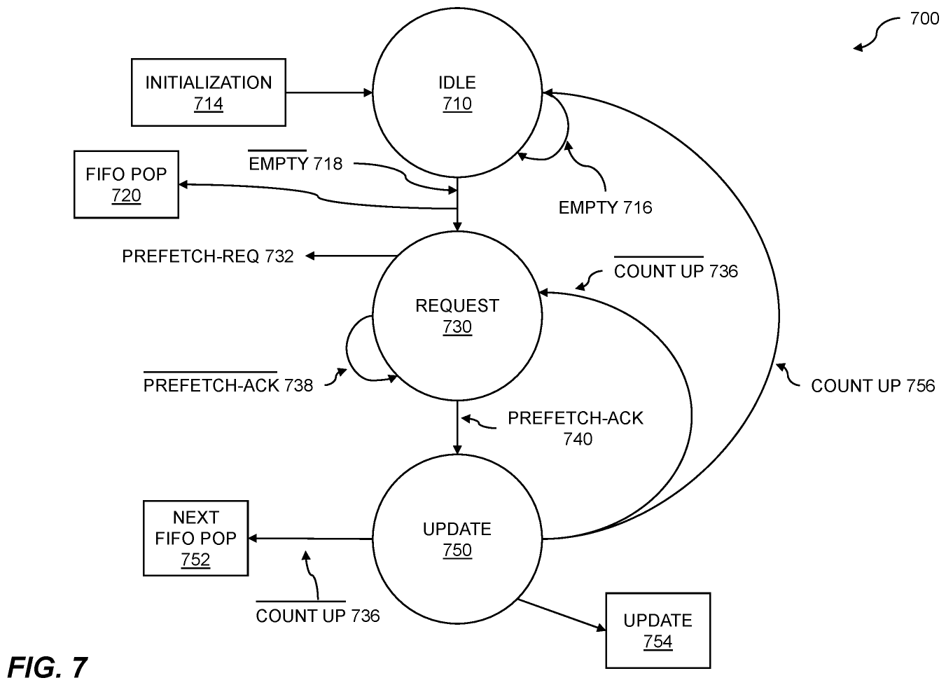

FIG. 7 is a state machine 700 for prefetching with saturation control. The finite state machine 700 can be a deterministic finite state machine. Upon a reset, an initialization 714 is performed. The initialization can include setting a default value for the stride count, saturation mode, out-of-order execution mode, stride factor, and/or other information. The initialization can include writing default values to a software-updatable configuration register. An idle state 710 is an initial state. A not empty indication 718 can occur when the FIFO (e.g., 640 of FIG. 6) has available data. The FSM then issues a FIFO POP 720 to retrieve the next record from a FIFO. Based on the retrieved information, the FSM enters the request state 730. In the request state 730, the FSM issues a prefetch request 732. While there is no prefetch acknowledge, as indicated by 738, the FSM remains in the request state 730. The prefetch acknowledge 740, once it arrives, causes the FSM to transition to the update state 750. The update state 750 can include updating a stride count and/or prefetch address values at update block 754. The change in stride count is indicated by the count up signal 756, indicative of a successful prefetch, which causes the FSM to transition to the idle state 710. If the update is not successful, the not count up signal 736 causes the FSM to return to the request state 730, and performs the next FIFO POP 752. As long as the FIFO remains empty, the empty signal 716 causes the FSM to remain in idle state 710. If the FIFO is not empty, the not empty indication 718 causes the FSM to enter the request state 730 to continue prefetcher operations.

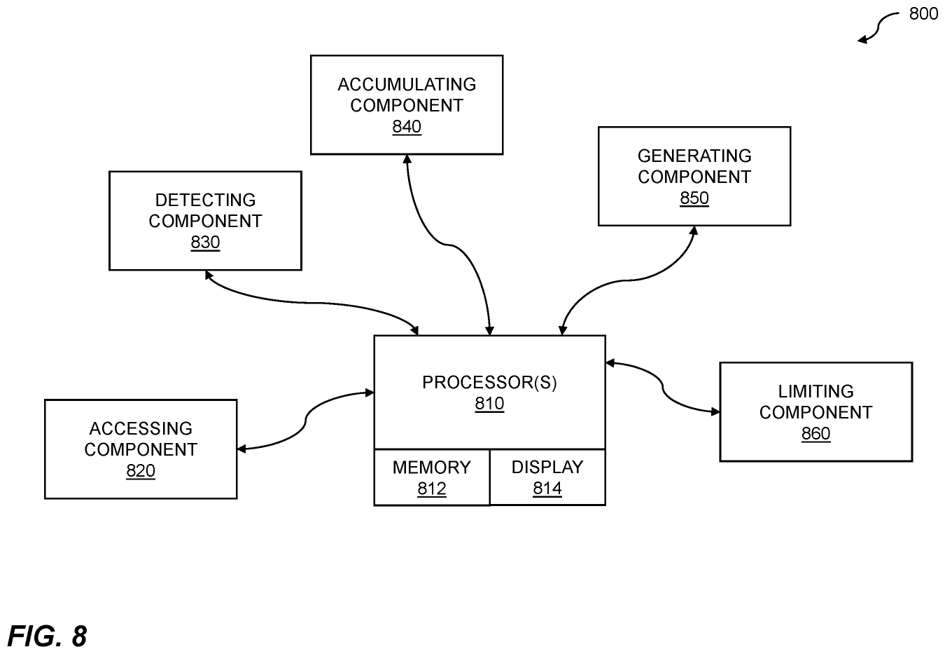

FIG. 8 is a system diagram for configurable prefetching with throttle control. The system 800 can include instructions and/or functions for design and implementation of integrated circuits that support prefetching with saturation control. The system 800 can include instructions and/or functions for generation and/or manipulation of design data, such as hardware description language (HDL) constructs, for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 800 can include one or more processors 810. The processors can include standalone processors within integrated circuits or chips, processor cores in field-programmable gate arrays (FPGAs) or application-specific integrated circuits (ASICs), and so on. The one or more processors 810 are attached to a memory 812, which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores. In embodiments, the processor cores can include RISC-V™ processor cores.

The system 800 can include an accessing component 820. The accessing component 820 can include functions and instructions for processing design data for accessing a processor core. The processor core can include FPGAs, ASICs, etc. In embodiments, the processor core can include a RISC-V™ processor core. The processor core can support prefetcher operations with saturation control as described previously.

The system 800 can include a detecting component 830. The detecting component 830 can include functions and instructions for processing design data for detecting a stride of a data stream, wherein the data stream comprises two or more load instructions, wherein the two or more load instructions cause two or more misses in the local cache hierarchy. The local cache hierarchy can include a local cache, L2 cache, L3 cache, global cache, prefetch cache, and/or other cache structures.

The system 800 can include an accumulating component 840. The accumulating component 840 can include functions and instructions for processing data for accumulating information about the data stream, wherein the information includes a stride count. In addition to a stride count, the accumulated information can also include, but is not limited to, a stride depth, a number of cache misses, a number of cache hits, and/or an out-of-order execution status.

The system 800 can include a generating component 850. The generating component 850 can include functions and instructions for processing design data for generating, based on the accumulated information, one or more prefetch operations, to the memory system, wherein the one or more prefetch operations incudes a prefetch address. The one or more prefetch operations can include multiple prefetch operations. In some embodiments, the one or more prefetch operations each include four prefetch operations.

The system 800 can include a limiting component 860. The limiting component 860 can include functions and instructions for limiting a rate of the one or more prefetch operations based on the stride count. The limiting component can serve to prevent the prefetching of data too early. If data is prefetched too early, there is an increased chance that the prefetched data may not be used. Prefetched data that is ultimately not used wastes computing resources such as clock cycles and memory bandwidth. The limiting, which can include the prefetcher entering a saturation mode, serves to mitigate this situation, while still obtaining benefits of prefetching data. In some embodiments, the limiting can include limiting prefetch operations to a single prefetch per cycle.

The system 800 can include a computer program product embodied in a non-transitory computer readable medium for prefetching, the computer program product comprising code which causes one or more processors to generate semiconductor logic for: accessing a processor core, wherein the processor core includes prefetch logic and a local cache hierarchy, and wherein the processor core is coupled to a memory system; detecting a stride of a data stream, wherein the data stream comprises two or more load instructions, wherein the two or more load instructions cause two or more misses in the local cache hierarchy; accumulating information about the data stream, wherein the information includes a stride count; generating, based on the information, one or more prefetch operations, to the memory system, wherein the one or more prefetch operations each includes a prefetch address; and limiting a rate of the one or more prefetch operations based on the stride count.

The system 800 can include a components that are configured to produce an apparatus for prefetching comprising: a processor core coupled to a memory system wherein the processor core and the memory system are used to perform operations comprising: accessing the processor core, wherein the processor core includes prefetch logic and a local cache hierarchy, and wherein the processor core is coupled to the memory system; detecting a stride of a data stream, wherein the data stream comprises two or more load instructions, wherein the two or more load instructions cause two or more misses in the local cache hierarchy; accumulating information about the data stream, wherein the information includes a stride count; generating, based on the information, one or more prefetch operations, to the memory system, wherein the one or more prefetch operations each includes a prefetch address; and limiting a rate of the one or more prefetch operations based on the stride count.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for prefetching comprising:
accessing a processor core, wherein the processor core includes prefetch logic and a local cache hierarchy, and wherein the processor core is coupled to a memory system;
detecting a stride of a data stream, wherein the data stream comprises two or more load instructions, wherein the two or more load instructions cause two or more misses in the local cache hierarchy;
accumulating information about the data stream, wherein the information includes a stride count;
generating, based on the information, one or more prefetch operations, to the memory system, wherein the one or more prefetch operations each includes a prefetch address; and
limiting a rate of the one or more prefetch operations based on the stride count.

2. The method of claim 1 wherein the generating further comprises performing a first number of stride prefetch operations which is based on the stride of the data stream, wherein the first number is stored in a software-updatable configuration register array.

3. The method of claim 2 further comprising identifying a continuation of the stride of the data stream, wherein the continuation of the data stream comprises two or more additional load instructions, wherein the two or more additional load instructions cause two or more second misses in the local cache hierarchy.

4. The method of claim 3 further comprising performing a second number of stride prefetch operations which is based on the stride of the data stream, wherein the second number is stored in the software-updatable configuration register array.

5. The method of claim 4 further comprising recognizing a second continuation of the stride of the data stream, wherein the second continuation of the data stream comprises two or more further load instructions, wherein the two or more further load instructions cause two or more third misses in the local cache hierarchy.

6. The method of claim 5 wherein the limiting further comprises performing a third number of stride prefetch operations, wherein the third number is stored in the software-updatable configuration register array.

7. The method of claim 6 wherein a saturate bit in a prefetch cache is set.

8. The method of claim 7 wherein an out-of-order stride count bit in a prefetch cache is set.

9. The method of claim 1 wherein the detecting is accomplished using a prefetch cache.

10. The method of claim 9 wherein the prefetch cache comprises a tag cache and a data cache.

11. The method of claim 10 wherein the prefetch address is based on a load address that missed in the local cache hierarchy, information from the tag cache, information from the data cache, and the stride of the data stream.

12. The method of claim 10 wherein the data cache includes the stride of the data stream.

13. The method of claim 10 wherein the data cache includes the stride count of the data stream.

14. The method of claim 10 wherein the data cache includes a saturate bit.

15. The method of claim 10 wherein the data cache includes an out-of-order stride count of the data stream.

16. The method of claim 1 further comprising identifying a second stride in the data stream.

17. The method of claim 16 further comprising halting the one or more prefetch operations, wherein the second stride is different than the stride.

18. The method of claim 1 further comprising preventing the generating one or more prefetch operations until the stride count is above a threshold, wherein the threshold is stored in a software-updatable configuration register array.

19. The method of claim 1 further comprising monitoring a performance counter in the local cache hierarchy.

20. The method of claim 19 wherein the generating one or more prefetch operations is reduced based on the performance counter above a threshold value.

21. The method of claim 20 wherein the threshold value is stored in a software-updatable configuration register array.

22. The method of claim 1 wherein the generating further comprises performing at least one sequential prefetch operation.

23. The method of claim 22 wherein the at least one sequential prefetch operation is based on a next sequential memory location.

24. The method of claim 1 further comprising initiating the prefetch logic, wherein the initiating is based on one or more misses by the two or more load instructions.

25. A computer program product embodied in a non-transitory computer readable medium for prefetching, the computer program product comprising code which causes one or more processors to generate semiconductor logic for:
accessing a processor core, wherein the processor core includes prefetch logic and a local cache hierarchy, and wherein the processor core is coupled to a memory system;
detecting a stride of a data stream, wherein the data stream comprises two or more load instructions, wherein the two or more load instructions cause two or more misses in the local cache hierarchy;
accumulating information about the data stream, wherein the information includes a stride count;
generating, based on the information, one or more prefetch operations, to the memory system, wherein the one or more prefetch operations each includes a prefetch address; and
limiting a rate of the one or more prefetch operations based on the stride count.

26. An apparatus for prefetching comprising:
a processor core coupled to a memory system, wherein the processor core and the memory system are used to perform operations comprising:
accessing the processor core, wherein the processor core includes prefetch logic and a local cache hierarchy, and wherein the processor core is coupled to the memory system;
detecting a stride of a data stream, wherein the data stream comprises two or more load instructions, wherein the two or more load instructions cause two or more misses in the local cache hierarchy;
accumulating information about the data stream, wherein the information includes a stride count;
generating, based on the information, one or more prefetch operations, to the memory system, wherein the one or more prefetch operations each includes a prefetch address; and
limiting a rate of the one or more prefetch operations based on the stride count.
